(19) United States
(12) Patent Application Publication
(10) Pub. No.: US 2026/0142592 A1
(43) Pub. Date: May 21, 2026

(54) Electrohydraulic and Piezoelectric Based Energy Conversion System

(71) Applicant: Robinson Alexander Ochoa Echeverri, Medellin (CO)

(72) Inventor: Robinson Alexander Ochoa Echeverri, Medellin (CO)

(73) Assignee: Robinson Alexander Ochoa Echeverri, VIRAZEIL (FR)

(21) Appl. No.: 18/951,778

(22) Filed: Nov. 19, 2024

(51) Int. Cl. H02N 2/18

(52) U.S. Cl. CPC H02N 2/185

(57) ABSTRACT

This invention introduces a novel energy conversion system and method that synergistically combines the electrohydraulic and piezoelectric effects to enhance electricity generation efficiency. By leveraging the overunity energy potential of cavitation, the system achieves exceptionally high energy efficiency for producing electrical energy. It features a hermetically sealed container filled with a pressurized dielectric liquid, electrodes connected to a high-voltage power source to induce cavitation, and a geometric shape incorporating piezoelectric material to directly convert energy from pressure shock waves into electricity. This approach uniquely exploits cavitation dynamics to generate sustainable and efficient electrical power, offering a scalable solution adaptable to various applications. The invention has the potential to revolutionize renewable energy systems by providing a cleaner and highly efficient source of electricity.

### CROSS-REFERENCE TO RELATED APPLICATIONS

This application claims the benefit of provisional application 63/602,586 filled Nov. 25, 2023, the entirety of which is incorporated herein by reference.

### FIELD OF THE INVENTION

This invention relates to a system and method for generating electricity by combining the electrohydraulic effect and piezoelectric effect, improving energy conversion efficiency by fully utilize the energy released during cavitation collapse.

### BACKGROUND OF THE INVENTION

Historically, the electrohydraulic and piezoelectric effects have been considered competing rather than complementary technologies due to their perceived similar ability to produce pressure waves. However, piezoelectric materials can produce these pressure waves without requiring high voltages, reducing the complexity, weight, and the need to work with potentially dangerous high voltages. This advantage has led to the replacement of electrohydraulic devices by piezoelectric materials in many applications. Also unlike the electrohydraulic effect, the piezoelectric effect is reversible, meaning it can also generate electricity from pressure. While both the electrohydraulic and piezoelectric effects have been utilized separately for various applications, the present invention provides a novel approach by uniquely combining these effects for energy conversion.

For example, some inventions focus primarily on using the electrohydraulic effect for the generation of shock waves to fast deform a working material like U.S. Pat. No. 7,516,634 B1. These systems do not incorporate the piezoelectric effect or aim to directly generate electrical energy with high efficiency.

It is very common that inventions that convert pressure waves to electricity use the piezoelectric effect, like U.S. Patent US2012247947A1,which uses acoustic drivers to produce cavitation in a resonator chamber. Still other inventions, like China patent CN113206619A, convert a constant flow to a pulsating flow and then use a mechanical amplification device that generates vibration. While these patents use the piezoelectric effect and some kind of resonance and/or cavitation, these systems do not incorporate the electrohydraulic effect and do not implement our techniques and methods to improve energy conversion efficiency.

Furthermore, no known prior art leverages the overunity potential of cavitation to achieve net energy gain as the present invention does. By synergistically combining the electrohydraulic and piezoelectric effects, this invention not only generates electricity but also harnesses the excess energy released during cavitation collapse, leading to significantly improved energy conversion efficiency. This unique approach, with its unexpected synergistic effects, distinguishes the present invention from mere combinations of known technologies.

Despite these advancements, there remains a need for more efficient and effective energy conversion systems that can synergistically harness both the electrohydraulic and piezoelectric effects. The present invention addresses this need by providing a novel system and method that not only generates electricity but also achieves exceptionally high energy efficiency by harnessing the overunity potential of cavitation.

### SUMMARY OF THE INVENTION

The invention provides a novel system and method for generating electricity by synergistically combining the electrohydraulic effect and the piezoelectric effect, with a specific focus on exceptionally high energy conversion efficiency by fully utilize the energy released during cavitation collapse. The system comprises a geometric shape housed within a sealed container filled with a dielectric liquid, a positive electrode and a negative electrode connected to a high-voltage power source to induce cavitation, and a piezoelectric material integrated into the geometric shape to harness the energy released from cavitation. The method involves applying a high voltage to the electrodes to create cavitation that generate pressure shock waves in the dielectric liquid, converting the released energy into electricity using the piezoelectric material.

### BRIEF DESCRIPTION OF THE DRAWINGS

FIG. 01 shows a basic implementation of the invention.

FIG. 02 shows a cross-section of the geometric shape.

FIG. 03 shows a hydraulic parametric resonant implementation of the geometric shape with cavitation generated outside the geometric shape.

FIG. 04 shows a hydraulic parametric resonant implementation of the geometric shape with cavitation generated inside the geometric shape.

FIG. 05 shows an example of optimal location of the piezoelectric material around the cavitation bubble.

### DETAILED DESCRIPTION OF THE INVENTION

The present invention discloses an energy conversion system that synergistically combines the electrohydraulic effect and the piezoelectric effect to generate electricity. The system comprises a geometric shape hermetically sealed in a container filled with a pressurized dielectric liquid, a positive electrode and a negative electrode connected to a high-voltage power source, a piezoelectric material strategically located within the geometric shape directly converts the mechanical energy from the pressure shock waves generated by cavitation into electrical energy, and electrical output cables. The method involves applying a high voltage to the electrodes to create pressure shock waves in the dielectric liquid, which are then harnessed and converted into electricity by the piezoelectric material.

Notably, the electrohydraulic effect in this system involves the formation of cavities within the dielectric liquid. These cavities, generated by the high-voltage discharge, undergo rapid collapse, a phenomenon known as cavitation.

The pressure in the hermetically sealed container has two functions:
a. Increase the amount of electricity generated by the piezoelectric material. The amount of electricity generated by the piezoelectric material is directly proportional to the range of pressures it is exposed to. Due to the cavitation process going from near-vacuum pressures to pressures as high as 100 MPa to 1000 MPa, higher baseline pressures in the container result in a wider range of pressure variation and thus, more electricity produced. This represents a dramatic increase in energy extraction without requiring additional energy input, as it stems from the initial pressurization of the container.
b. Create more energetic pressure shock waves. At higher pressures in the container, the greater the force with which the cavitation bubbles collapse, the more energy is liberated by the pressure shock waves generated. The forceful collapse of the cavitation bubbles under higher pressure results in more energy being released, which can then be harnessed by the piezoelectric material.

The limit of the pressure of the container is the maximum that the piezoelectric material can sustain without damage.

Cavitation is known to exhibit an overunity phenomenon, where the energy released during cavity collapse can exceed the energy required to create the cavity. This phenomenon has been documented in various studies (Plesset, M. S., and Chapman, R. B. (1971). “Collapse of an initially spherical vapour cavity in the neighbourhood of a solid boundary.” Journal of Fluid Mechanics, 47(2). Regiane, Fortes P., et al. (2003). “Cavitation erosion mechanism: numerical simulations of the impact of a cavitation bubble on a solid surface.” Ecole Nationale d'Ingénieurs de Saint Etienne. Flannigan, D. J., & Suslick, K. S. (2005). Plasma formation and temperature measurement during single-bubble cavitation. Nature, 434(7029)). While the exact mechanism behind this overunity phenomenon is still under investigation, it is hypothesized that factors such as energy concentration during bubble collapse, shockwave interactions, and even potentially nuclear reactions at the point of collapse may contribute to the observed energy increase. The present invention achieves exceptionally high energy conversion efficiency by fully utilize the energy released during cavitation collapse.

The geometric shape is composed of an external layer made of a material with a high tensile modulus, an optional intermediate layer having a tensile modulus similar to that of the piezoelectric material, a central layer made of a piezoelectric material, and an optional internal layer made of a material with the same tensile modulus as the piezoelectric material.

The high tensile modulus of the external layer is crucial for maximizing the power output of the piezoelectric material. It achieves this by preventing the outward expansion of the piezoelectric material's outer radius when subjected to pressure waves. This constraint ensures that the piezoelectric material experiences the full intensity of the internal pressure, leading to increased mechanical stress and a higher energy conversion efficiency.

The optional layers, when present, serve to protect the piezoelectric material from damage due to repeated expansion and contraction cycles induced by the pressure waves. By matching the tensile modulus of the piezoelectric material, these layers help to distribute stress and strain evenly, preventing deformation, cracking, or delamination of the piezoelectric material and ensuring the long-term durability and performance of the device.

In one embodiment, the geometric shape is implemented as a hydraulic parametric resonant geometry to produce multiple pressure waves from the original pressure wave created.

In another embodiment, the point of generation of pressure waves is located inside the geometric shape.

In another embodiment, a combustible cable is strategically positioned between the electrodes. Upon initiation of the electrohydraulic effect, the high voltage applied to the electrodes ignites the combustible cable, causing a rapid phase transition of the cable's material from solid to gas. This phase transition generates a substantial increase in pressure within the sealed container, further amplifying the energy conversion process.

The combustible cable is preferably composed of a material that combusts rapidly and completely to maximize the pressure increase within the sealed container. This material should also be resistant to dissolution or degradation in the dielectric liquid, whether it's water or other liquids like glycerol. Suitable materials include magnesium-based alloys, thermite compositions, or specialized pyrotechnic compositions designed for controlled gas generation, such as those containing nitrocellulose or black powder.

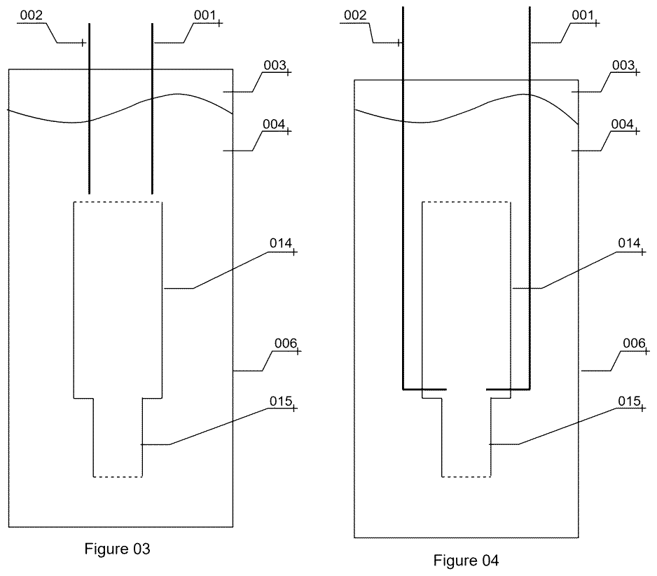

In one hydraulic parametric resonance embodiment, as shown in FIG. 03, the geometric shape 005 is implemented as a hydraulic parametric resonant chamber comprising two interconnected cylindrical sections with different diameters and lengths. A piezoelectric tube 014 with length L2 and cross-sectional area A2 is connected to a second piezoelectric tube 015 with length L1 and cross-sectional area A1. These tubes differ in length and cross-sectional area but maintain a parametric resonance geometric relationship, enabling the production of multiple pressure waves from the initial pressure wave created.

Parametric resonance occurs when the pressure waves are modulated periodically as they propagate through this varying geometry, resulting in the amplification of certain vibrational modes. To achieve hydraulic parametric resonance, the lengths and cross-sectional areas of the tubes are chosen such that their natural frequencies satisfy a specific ratio, typically a 2:1 ratio. This configuration allows the initial pressure wave to excite the resonant modes of the chamber, generating multiple pressure waves and amplifying the overall output.

In another embodiment, the power output of the device can be additionally enhanced if the geometric shape is designed to operate at resonant or parametric resonant of the piezoelectric material 010.

In another embodiment, to improve the power output, the piezoelectric material is excited by an input signal through its output cables that induces parametric resonance in the material.

### DETAILED DESCRIPTION OF THE DRAWINGS

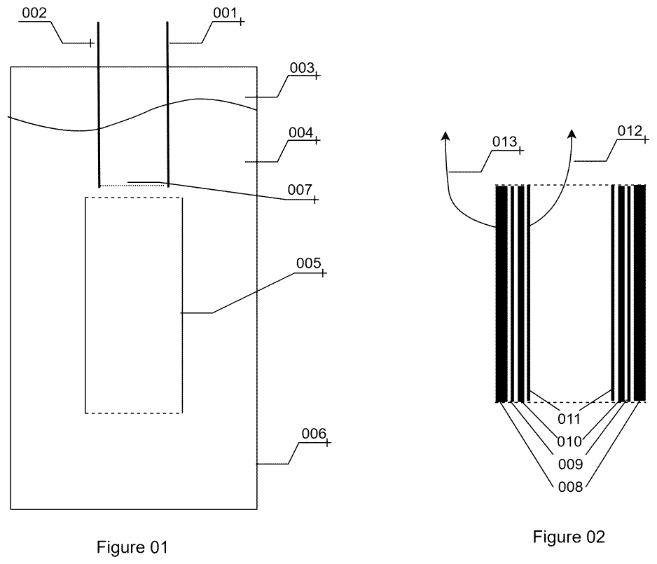

FIG. 01 shows a basic implementation of the invention. It illustrates a hermetically sealed container 006 filled with a pressurized dielectric fluid 004, such as distilled water or glycerol, and optionally a pressurized gas 003, such as nitrogen or air. The apparatus features a positive electrode 001 and a negative electrode 002, both made of conductive materials like copper or steel, connected to a high-voltage power source. An optional combustible cable 007 is placed between the electrodes, which will be converted into gas at the start of the process. A geometric shape 005 is submerged within the fluid.

FIG. 02 shows a cross-section of the geometric shape 005. It may be composed of up to four layers. The outermost layer 008 is made of a high-tensile modulus material, such as steel 4340 or 17-4 PH. An optional intermediate layer 009 may be present, having a tensile modulus similar to that of the piezoelectric material. The central layer 010 is the piezoelectric material, which should have a high coupling factor, high density, and high dielectric constant, such as PZT. An optional internal layer 011 may be present, made of a material with a tensile modulus similar to that of the piezoelectric material. The outermost layer is connected to a negative electrical power output cable 013, and the inner layer is connected to a positive electrical power output cable 012. These cables are connected to a load (not shown).

FIG. 03 shows a hydraulic resonant implementation of the geometric shape. In this embodiment, a piezoelectric tube 014 with length L2 and cross sectional area A2 is connected to a second piezoelectric tube 015 with length L1 and cross-sectional area A1.

FIG. 04 shows an alternative location for the point of generation of the cavitation, pressure waves. In this embodiment, the pressure waves are generated inside the piezoelectric material at the internal ends of the electrodes.

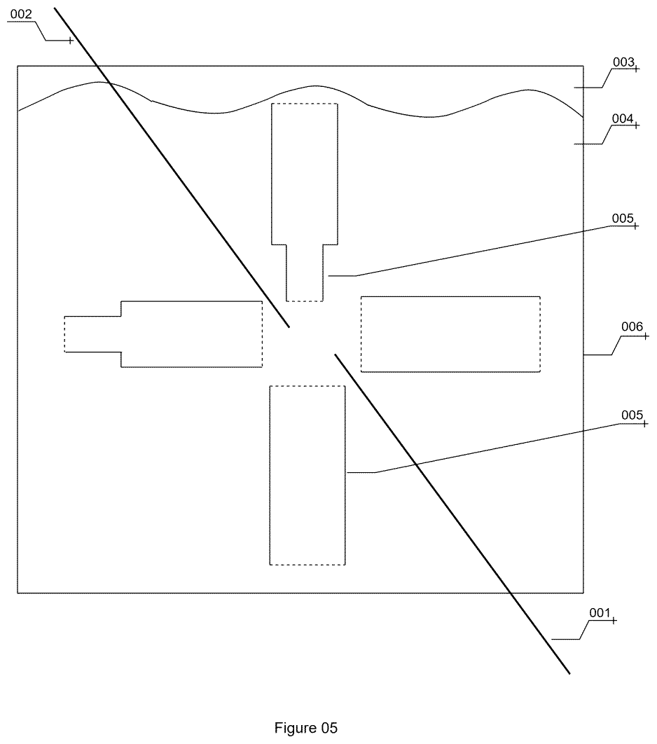

FIG. 05 shows an example of the optimal location of the piezoelectric material around the cavitation bubble, generated by the electrohydraulic effect.

1. An energy conversion device comprising:
a. A hermetically sealed container capable of withstanding pressures generated during cavitation collapse in the range of 100 MPa to 1000 MPa, filled with a pressurized dielectric liquid, said container housing a geometric shape comprising:
i. An external layer comprising a material capable of resisting deformation under high-pressure conditions, caused by the pressure waves, configured to maximize power output by preventing outward expansion of the piezoelectric material;
ii. A central layer comprising a piezoelectric material having a high coupling factor, high density, and high dielectric constant;
iii. Optional intermediate layers positioned between the external layer and the central layer, comprising a material with a tensile modulus similar to that of the piezoelectric material, said intermediate layers configured to protect the piezoelectric material from damage; and.
iv. Optional internal layers positioned within the central piezoelectric layer, comprising a material with a tensile modulus similar to that of the piezoelectric material, said internal layers configured to protect the piezoelectric material from damage.
b. A positive electrode and a negative electrode positioned within said chamber and connected to a high-voltage power source, said electrodes configured to generate cavitation within the dielectric liquid in proximity to the geometric shape; and.
c. Power output cables connected to the piezoelectric material and configured to deliver electrical energy to a load.

2. The device of claim 1, wherein the electrodes are positioned to generate cavitation either outside or within the geometric shape.

3. The device of claim 1, wherein the geometric shape comprising two interconnected cylindrical sections with different diameters and lengths. optimized to induce hydraulic parametric resonance by creating pressure waves of varying intensities.

4. The device of claim 1, wherein the hermetically sealed container is filled with a dielectric liquid and optionally a pressurized gas, the dielectric liquid comprising water, glycerol, or any electrically insulating fluid capable of sustaining cavitation, and the pressurized gas selected from, but not limited to, nitrogen, air, noble gases, or any gas capable of enhancing cavitation dynamics.

5. The device of claim 1, further comprising a combustible cable positioned between the positive and negative electrodes, wherein the rapid phase transition of the cable's material from solid to gas upon ignition by the high-voltage discharge increases the pressure in the sealed container, improving the power output.

6. A method for producing electricity comprising:
a. Applying a high voltage to a positive electrode and a negative electrode in a geometric shape housed within a sealed container filled with a pressurized dielectric liquid, thereby inducing cavitation in the
dielectric liquid in proximity to the geometric shape;
b. Converting the mechanical energy from the cavitation into electricity using a piezoelectric material located in the geometric shape within the sealed container; and
c. Collecting the electrical energy produced by the piezoelectric material.

7. The method of claim 6, wherein the geometric shape comprises two interconnected cylindrical sections with different diameters and lengths optimized to induce hydraulic parametric resonance.

8. The method of claim 6, wherein a combustible cable is present between the positive and negative electrodes.

9. The method of claim 6, wherein the piezoelectric material is strategically placed to surround the point of cavitation.

10. The method of claim 6, wherein the geometric shape is designed to operate at resonance or parametric resonance of the piezoelectric material.

11. The method of claim 6, wherein the piezoelectric material is excited by an input signal that induces parametric resonance in the material, which in turn increases the output power generated by the piezoelectric device.
